(19) United States
(12) Patent Application Publication
(10) Pub. No.: US 2007/0276805 A1
(43) Pub. Date: Nov. 29, 2007

(54) Human Interface Device for Facilitating Website Browses

(76) Inventor: Cheng-Su Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/420,799

(22) Filed: May 29, 2006

(51) Int. Cl. G06F 17/30

(52) U.S. Cl. 707/3

(57) ABSTRACT

A human interface device for facilitating website browses includes a first reception module for transforming a human feature of a user into human feature data, a second reception module for receiving security data corresponding to a website from the user, a storage module for storing the security data and the human feature data, and a logic module for applying the security data to the website when the user browses the website.

### BACKGROUND OF THE INVENTION

1. Field of the Invention

The present invention provides a human interface device, and more particularly, a human interface device for facilitating website browses.

2. Description of the Prior Art

As information technology is being upgraded with each passing day, Internet has become an essential in an information society. Through Internet, a user can get the latest news, place an order for a concert, buy a product, enjoy TV programs, etc.

In order to manage Internet resources or keep personal information, many websites ask users for personal security data, such as a username and a corresponding password, to be of service. That is, only if a user keys in the correct username and the corresponding password can the user login a website or execute some functions of the website. As a result, the user needs to keep in mind a lot of usernames and passwords of different websites, such as web banks, online games, discussing boards, web-mail servers, etc. Although the user can use one username and one password for all website logins, yet it is unwise and insecure because it may be a disaster if the username and the password are stolen. Also, different websites have different formats of usernames and passwords; some may use arbitrary words, and some may use driver license numbers as the login usernames, for example. However, except keeping the usernames and the passwords in mind, there is no any safe way for the user to remember the usernames and the passwords.

Therefore, how to facilitate browsing website without remembering different usernames and passwords for users has become a research and development issue in information companies.

### SUMMARY OF THE INVENTION

It is therefore a primary objective of the claimed invention to provide a human interface device.

According to the claimed invention, a human interface device for facilitating website browses includes a first reception module for transforming a human feature of a user into human feature data, a second reception module for receiving security data corresponding to a website from the user, a storage module for storing the security data and the human feature data, and a logic module for applying the security data to the website when the user browses the website.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a human interface device in accordance with the present invention.

FIG. 2 illustrates a block diagram of a logic module in accordance with an embodiment of the present invention.

FIG. 3 illustrates a schematic diagram of a look-up table.

FIG. 4 illustrates a schematic diagram of a mouse in accordance with an embodiment of the present invention.

### DETAILED DESCRIPTION

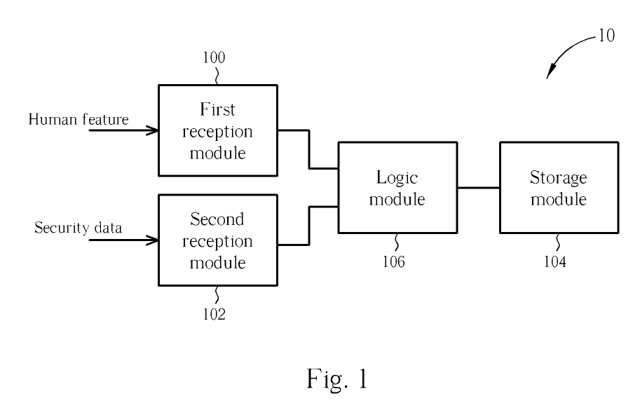

Please refer to FIG. 1, which illustrates a schematic diagram of a human interface device 10 in accordance with the present invention. The human interface device 10 can facilitate website browses, and includes a first reception module 100, a second reception module 102, a storage module 104, and a logic module 106. The first reception module 100 transforms a human feature of a user into human feature data. The second reception module 102 receives security data corresponding to a website from the user. The storage module 104 stores the security data and the human feature data. The logic module 106 applies the security data to the website when the user browses the website. Therefore, the human interface device 10 stores the human feature data and the security data of the website received from the user through the first reception module 100 and the second reception module 102. After that, if the user accesses or logins the website again, the human interface device 10 can apply the stored security data to the website, so that the user need not keep in mind the security data, such as usernames and corresponding passwords.

In the present invention, the human feature can be fingerprint, voiceprint, palm print, iris, or other characteristics of the user, utilized for uniquely identifying the user. The security data is utilized for managing Internet resources or keeping personal information, and it can be a username and corresponding password, crypto, etc. Since the human feature of the user is unique and always with the user, the user may forget a username or a password of a website, but the user won't lost the human feature in normal cases. Therefore, the human feature is taken as a key of the security data of the website, so that the user need not remember the security data all the time.

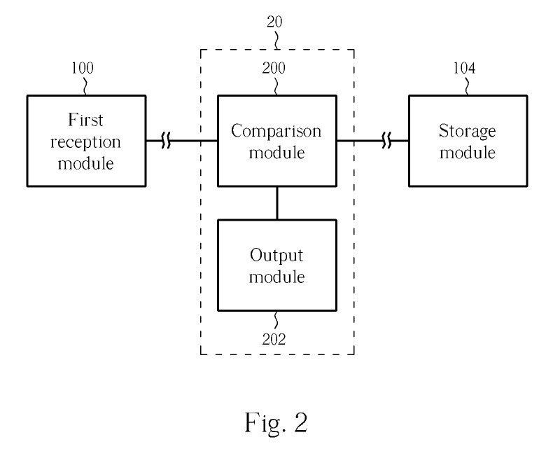

Please refer to FIG. 2, which illustrates a block diagram of a logic module 20 in accordance with an embodiment of the present invention. The logic module 20 is utilized for implementing the logic module 106 shown in FIG. 1, and includes a comparison module 200 and an output module 202. The comparison module 200 compares data received by the first reception module 100 and the human feature data stored in the storage module 104. If a result of the comparison module 200 represents that the data received by the first reception module 100 conforms to the human feature data stored in the storage module 106, the output module 202 applies the security data to the corresponding website. That is, when a user is browsing a website, the first reception module 100 can receive a human feature of the user and transforms into a human feature data. Then, the comparison module 200 compares the received human feature data with the human feature data corresponding to the website in the storage module 104. If the received human feature data conforms to the human feature data in the storage module 104, the output module 202 can output the security data of the website stored in the storage module 202 to related fields of the website. Therefore, the user need not key in the username or password, but is allowed to login or access the website. Note that, the logic module 20 shown in FIG. 2 is an embodiment of the logic module 106 shown in FIG. 1, and those skilled in the art may make alterations according to the present invention.

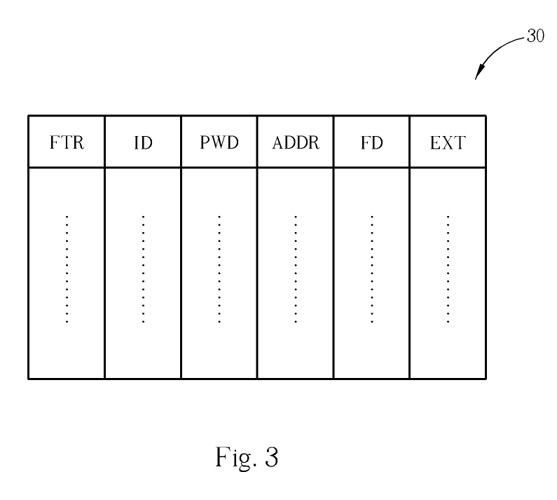

In the human interface device 10, the storage module 104 can be any kind of storage devices for storing the human feature data and the security data, such as flash memory, memory cards, etc. Furthermore, when storing the human feature data and the security data into the storage module 104, the human interface device 10 can establish a database or a look-up table 30 in the storage module 104 as shown in FIG. 3, for example. The look-up table 30 includes fields of FTR, ID, PWD, ADDR, FD, and EXT, corresponding to human feature data, usernames, passwords, website addresses, fields in websites, and extension functions. Therefore, the human interface device 10 can store the human feature data and the security data corresponding to the fields of the look-up table 30, so that the logic module 106 can inquire data in a row if human feature data received by the first reception module 100 conforms to human feature data of the row. In addition, the storage module 104 can store data by encoding data with a key corresponding to the human feature data, so as to keep personal data security.

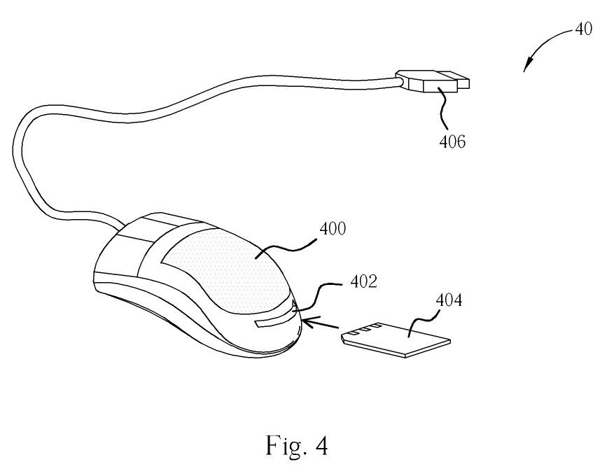

Therefore, using the human interface device 10, the user does not have to keep a lot of usernames and passwords in mind, but does login a website with the user's human feature, such as fingerprint, voiceprint, palm print, iris, or other characteristics. The human interface device 10 can be an input device of a computer, PDA, mobile phone, etc. For example, please refer to FIG. 4, which illustrates a schematic diagram of a mouse 40 in accordance with an embodiment of the present invention. The mouse 40 exchanges signals with a computer through a USB terminal 406, and includes a palm-print recognizer 400 and an SD card slot 402. The palm-print recognizer 400 can recognize a user's palm print. The SD card slot 402 can load an SD card 404 for storing human feature data of users and security data of websites. When a user enters a username and a password for browsing a website, a logic module (not shown in FIG. 4) of the mouse 40 can stores the user's palm-print data, the username, and the password into the SD card 404 using an encryption key corresponding to the user's palm-print data. After that, once the user browses the website, the palm-print recognizer 400 can recognize the user's palm print, and the logic module will obtain and apply the username and the password from the SD card 404 to the website, so that the user does not have to remember the username and password.

In summary, the present invention stores human feature data of a user and security data of websites, and applying security data to a websites when the user browses the website. Therefore, the user does not have to remember usernames and passwords of different websites, which can facilitate browsing websites and keep personal data security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A human interface device for facilitating website browses, comprising:
a first reception module for transforming a human feature of a user into human feature data;
a second reception module for receiving security data corresponding to a website from the user;
a storage module for storing the security data and the human feature data; and
a logic module for applying the security data to the website when the user browses the website.

2. The human interface device of claim 1, wherein the human feature is a fingerprint characteristic of the user.

3. The human interface device of claim 1, wherein the human feature is a voiceprint characteristic of the user.

4. The human interface device of claim 1, wherein the human feature is a palm print characteristic of the user.

5. The human interface device of claim 1, wherein the human feature is an iris characteristic of the user.

6. The human interface device of claim 1, wherein the security data comprises a username and a password corresponding to the username.

7. The human interface device of claim 1, wherein the security data comprises a crypto corresponding to the user.

8. The human interface device of claim 1, wherein the storage module is a flash memory.

9. The human interface device of claim 1, wherein the storage module stores data by encoding data with a key corresponding to the human feature data.

10. The human interface device of claim 1, wherein the logic module comprises:
a comparison module for comparing data received by the first reception module with the human feature data stored in the storage module; and
an output module for applying the security data to the website when the data received by the first reception module conforms to the human feature data stored in the storage module according to a result of the comparison module.

11. The human interface device of claim 1, further comprising an interface for coupling the human interface device to an electric device.

12. The human interface device of claim 11, wherein the interface conforms to USB standard.

13. The human interface device of claim 11, wherein the electric device is a computer system.

14. The human interface device of claim 11, wherein the electric device is a personal digital assistant.

15. The human interface device of claim 11, wherein the electric device is a mobile phone.

16. The human interface device of claim 1 being a mouse.

17. The human interface device of claim 1 being a keyboard.
